(19) United States
(12) Patent Application Publication
(10) Pub. No.: US 2026/0032730 A1
(43) Pub. Date: Jan. 29, 2026

(54) METHOD AND DEVICE FOR RANDOM ACCESS IN WIRELESS COMMUNICATION SYSTEM

(71) Applicant: ELECTRONICS AND TELECOMMUNICATIONS RESEARCH INSTITUTE, Daejeon (KR)

(72) Inventor: Hee Wook KIM, Daejeon (KR)

(73) Assignee: ELECTRONICS AND TELECOMMUNICATIONS RESEARCH INSTITUTE, Daejeon (KR)

(21) Appl. No.: 18/995,113

(22) PCT Filed: Apr. 6, 2023
(86) PCT No.: PCT/KR2023/004664

§ 371 Date: Jan. 15, 2025

(30) Foreign Application Priority Data
Sep. 13, 2022 (KR) 10-2022-0115036

(51) Int. Cl. H04W 74/0833; H04J 13/00; H04L 27/26

(52) U.S. Cl. CPC H04W 74/0833; H04J 13/0062; H04L 27/26025

(57) ABSTRACT

An operation method of a terminal according to an embodiment of a method and device for random access in a wireless communication system comprises the steps of: receiving random access channel (RACH) configuration information from a base station included in a first network; generating a random access (RA) preamble including a plurality of different preamble sequences on the basis of the RACH configuration information; mapping the RA preamble to a first frequency domain; and transmitting, to the base station, the PA preamble mapped to the first frequency domain, wherein the size of the bandwidth occupied by the first frequency domain and the size of the bandwidth occupied by a physical uplink shared channel (PUSCH) in the first network may be set to have an integer multiple relationship with each other on the basis of the RACH configuration information.

### TECHNICAL FIELD

The present disclosure relates to a random access technique in a wireless communication system, and more particularly, to a random access technique for supporting a Doppler shift-resistant random access in a terrestrial cell, satellite cell, or the like.

### BACKGROUND ART

With the development of information and communication technology, various wireless communication technologies are being developed. Representative wireless communication technologies include long-term evolution (LTE) and new radio (NR) defined as the 3rd generation partnership project (3GPP) standards. The LTE may be one of the 4th generation (4G) wireless communication technologies, and the NR may be one of the 5th generation (5G) wireless communication technologies.

The NR communication network may provide communication services to terminals located on the ground. Recently, the demand for communication services for airplanes, drones, satellites, etc. located not only on the ground but also in non-terrestrial environments is increasing, and for this, non-terrestrial network (NTN) technologies are being discussed.

Meanwhile, due to different locations of terminals in a mobile communication network, propagation delays of signals between the respective terminals and a base station may be different. In order to reduce interference due to the different propagation delays of the terminals, a timing advance (TA) operation based on a random access (RA) procedure may be used. In particular, in the case of NTN, a propagation delay between a terminal and a base station is relatively large, a cell coverage is relatively wide, and effects of Doppler shifts may be large. Therefore, in addition to the RA procedure designed based on terrestrial networks, an RA technique for improving the RA performance in the NTN may be required.

Matters described as the prior arts are prepared to promote understanding of the background of the present disclosure, and may include matters that are not already known to those of ordinary skill in the technology domain to which exemplary embodiments of the present disclosure belong.

### DISCLOSURE

### Technical Problem

The present disclosure is directed to providing a method and an apparatus for supporting a Doppler shift-resistant RA operation in an NTN having a wide cell coverage and relatively high effects of Doppler shifts.

### Technical Solution

An operation method of a terminal, according to an exemplary embodiment of the present disclosure for achieving the above-described objective, may comprise:

receiving random access channel (RACH) configuration information from a base station included in a first network; generating a random access (RA) preamble including a plurality of different preamble sequences based on the RACH configuration information; mapping the RA preamble to a first frequency region; and transmitting the RA preamble mapped to the first frequency region to the base station, wherein a size of a bandwidth occupied by the first frequency region and a size of a bandwidth occupied by a physical uplink shared channel (PUSCH) in the first network are set to have an integer multiple relationship with each other based on the RACH configuration information.

The generating of the RA preamble may comprise: identifying information of a first format to be applied to the RA preamble based on information received from the base station; and generating the RA preamble based on the first format, wherein in the first format, a subcarrier spacing (SCS) configured for the RA preamble is set to have an integer multiple relationship with an SCS configured for the PUSCH.

The generating of the RA preamble may comprise: identifying information of a first format to be applied to the RA preamble based on information received from the base station; and generating the RA preamble based on the first format, wherein in the first format, a length of the RA preamble is set to have an integer multiple relationship with a length of an RA preamble used for an RA procedure in a second network having a coverage that is different from a cell coverage of the first network and overlaps at least partially with the cell coverage of the first network.

The generating of the RA preamble may comprise: generating a first preamble sequence and a second preamble sequence that are Zadoff-Chu sequences having a same size and generated based different root values; and generating the RA preamble such that the first and second preamble sequences are continuously arranged with one cyclic prefix (CP) interposed therebetween in time domain.

The generating of the RA preamble may comprise: generating a first preamble sequence and a second preamble sequence that are Zadoff-Chu sequences having a same size and generated based different root values; and generating the RA preamble such that the first and second preamble sequences are continuously arranged in time domain.

The generating of the RA preamble may comprise: generating a first preamble sequence and a second preamble sequence that are Zadoff-Chu sequences having a same size and generated based different root values; and generating the RA preamble such that the first and second preamble sequences are continuously arranged in frequency domain.

An operation method of a base station, according to an exemplary embodiment of the present disclosure for achieving the above-described objective, may comprise: transmitting random access channel (RACH) configuration information to one or more terminals included in a first network including the base station; receiving, from a first terminal among the one or more terminals, a random access (RA) preamble transmitted after being mapped to a first frequency region based on the RACH configuration information; and performing timing advance (TA) estimation for the first terminal based on a plurality of different preamble sequences included in the RA preamble, wherein a size of a bandwidth occupied by the first frequency region and a size of a bandwidth occupied by a physical uplink shared channel (PUSCH) in the first network are set to have an integer multiple relationship with each other based on the RACH configuration information.

The transmitting of the RACH configuration information may comprise: identifying a size of a cell of the base station; comparing the size of the cell with a first size reference; in response to that the size of the cell exceeds the first size reference, generating the RACH configuration information including information of a first format applied to the RA preamble; and transmitting the RACH configuration information to the one or more terminals.

In the first format, a subcarrier spacing (SCS) configured for the RA preamble may be set to have an integer multiple relationship with an SCS configured for the PUSCH.

In the first format, a length of the RA preamble may be set to have an integer multiple relationship with a length of an RA preamble used for an RA procedure in a second network having a coverage that is different from a cell coverage of the first network and overlaps at least partially with the cell coverage of the first network.

In the RA preamble, a first preamble sequence and a second preamble sequence that are Zadoff-Chu sequences having a same size and generated based different root values may be continuously arranged with one cyclic prefix (CP) interposed therebetween in time domain.

In the RA preamble, a first preamble sequence and a second preamble sequence that are Zadoff-Chu sequences having a same size and generated based different root values may be continuously arranged in frequency domain.

A terminal, according to an exemplary embodiment of the present disclosure for achieving the above-described objective, may comprise a processor, and the processor may cause the terminal to perform: receiving random access channel (RACH) configuration information from a base station included in a first network; generating a random access (RA) preamble including a plurality of different preamble sequences based on the RACH configuration information; mapping the RA preamble to a first frequency region; and transmitting the RA preamble mapped to the first frequency region to the base station, wherein a size of a bandwidth occupied by the first frequency region and a size of a bandwidth occupied by a physical uplink shared channel (PUSCH) in the first network are set to have an integer multiple relationship with each other based on the RACH configuration information.

In the generating of the RA preamble, the processor may further cause the terminal to perform: identifying information of a first format to be applied to the RA preamble based on information received from the base station; and generating the RA preamble based on the first format, wherein in the first format, a subcarrier spacing (SCS) configured for the RA preamble is set to have an integer multiple relationship with an SCS configured for the PUSCH.

In the generating of the RA preamble, the processor may further cause the terminal to perform: identifying information of a first format to be applied to the RA preamble based on information received from the base station; and generating the RA preamble based on the first format, wherein in the first format, a length of the RA preamble is set to have an integer multiple relationship with a length of an RA preamble used for an RA procedure in a second network having a coverage that is different from a cell coverage of the first network and overlaps at least partially with the cell coverage of the first network.

In the generating of the RA preamble, the processor may further cause the terminal to perform: generating a first preamble sequence and a second preamble sequence that are Zadoff-Chu sequences having a same size and generated based different root values; and generating the RA preamble such that the first and second preamble sequences are continuously arranged with one cyclic prefix (CP) interposed therebetween in time domain.

In the generating of the RA preamble, the processor may further cause the terminal to perform: generating a first preamble sequence and a second preamble sequence that are Zadoff-Chu sequences having a same size and generated based different root values; and generating the RA preamble such that the first and second preamble sequences are continuously arranged in time domain.

In the generating of the RA preamble, the processor may further cause the terminal to perform: generating a first preamble sequence and a second preamble sequence that are Zadoff-Chu sequences having a same size and generated based different root values; and generating the RA preamble such that the first and second preamble sequences are continuously arranged in frequency domain.

### Advantageous Effects

According to the exemplary embodiments of the random access method and apparatus in the wireless communication system, a PRACH bandwidth used by a UE for an RA procedure for a satellite base station in the communication system including an NTN may be set to (1/n) of a PUSCH bandwidth or set to (1/n) of a PRACH bandwidth in a terrestrial network (n is a natural number greater than 1). In addition, an RA preamble may be configured to include a plurality of different preamble sequences in the time domain or frequency domain. Through this, in the NTN having a wide cell coverage and a relatively high influence of Doppler shifts, an RA procedure with low complexity can be performed while maintaining compatibility with an RA procedure determined based on the terrestrial networks.

### DESCRIPTION OF DRAWINGS

FIG. 1 is a conceptual diagram illustrating an exemplary embodiment of a communication system.

FIG. 2 is a block diagram illustrating an exemplary embodiment of a communication node constituting a communication system.

FIG. 3 is a sequence chart illustrating an exemplary embodiment of an RA procedure in a communication system.

FIGS. 4A and 4B are conceptual diagrams for describing a first exemplary embodiment of an RA preamble structure in the communication system.

FIG. 5 is a conceptual diagram for describing propagation delays according to locations of satellites and terminals constituting an NTN in an exemplary embodiment of a communication system.

FIGS. 6A and 6B are conceptual diagrams for describing a second exemplary embodiment of an RA preamble structure in the communication system.

FIGS. 7A and 7B are conceptual diagrams for describing an exemplary embodiment of a method of mapping an RA preamble in the frequency domain in the communication system.

FIGS. 8A and 8B are conceptual diagrams for describing a third exemplary embodiment of an RA preamble structure in the communication system.

FIGS. 9A and 9B are conceptual diagrams for describing a fourth exemplary embodiment of an RA preamble structure in the communication system.

FIG. 10 is a conceptual diagram for describing a fifth exemplary embodiment of an RA preamble structure in the communication system.

FIG. 11 is a conceptual diagram for describing an exemplary embodiment of a delay time calculation method according to the fifth exemplary embodiment of the RA preamble structure in the communication system.

### BEST MODE OF THE INVENTION

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may refer to “at least one A or B” or “at least one of one or more combinations of A and B”. In addition, “one or more of A and B” may refer to “one or more of A or B” or “one or more of one or more combinations of A and B”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

A communication system to which exemplary embodiments according to the present disclosure are applied will be described. The communication system to which the exemplary embodiments according to the present disclosure are applied is not limited to the contents described below, and the exemplary embodiments according to the present disclosure may be applied to various communication systems. Here, the communication system may have the same meaning as a communication network.

Throughout the present disclosure, a network may include, for example, a wireless Internet such as wireless fidelity (WiFi), mobile Internet such as a wireless broadband Internet (WiBro) or a world interoperability for microwave access (WiMax), 2G mobile communication network such as a global system for mobile communication (GSM) or a code division multiple access (CDMA), 3G mobile communication network such as a wideband code division multiple access (WCDMA) or a CDMA2000, 3.5G mobile communication network such as a high speed downlink packet access (HSDPA) or a high speed uplink packet access (HSUPA), 4G mobile communication network such as a long term evolution (LTE) network or an LTE-Advanced network, 5G mobile communication network, beyond 5G (B5G) mobile communication network (e.g., 6G mobile communication network), or the like.

Throughout the present disclosure, a terminal may refer to a mobile station, mobile terminal, subscriber station, portable subscriber station, user equipment, access terminal, or the like, and may include all or a part of functions of the terminal, mobile station, mobile terminal, subscriber station, mobile subscriber station, user equipment, access terminal, or the like.

Here, a desktop computer, laptop computer, tablet PC, wireless phone, mobile phone, smart phone, smart watch, smart glass, e-book reader, portable multimedia player (PMP), portable game console, navigation device, digital camera, digital multimedia broadcasting (DMB) player, digital audio recorder, digital audio player, digital picture recorder, digital picture player, digital video recorder, digital video player, or the like having communication capability may be used as the terminal.

Throughout the present specification, the base station may refer to an access point, radio access station, node B (NB), evolved node B (eNB), base transceiver station, mobile multihop relay (MMR)-BS, or the like, and may include all or part of functions of the base station, access point, radio access station, NB, eNB, base transceiver station, MMR-BS, or the like.

Hereinafter, preferred exemplary embodiments of the present disclosure will be described in more detail with reference to the accompanying drawings. In describing the present disclosure, in order to facilitate an overall understanding, the same reference numerals are used for the same elements in the drawings, and duplicate descriptions for the same elements are omitted.

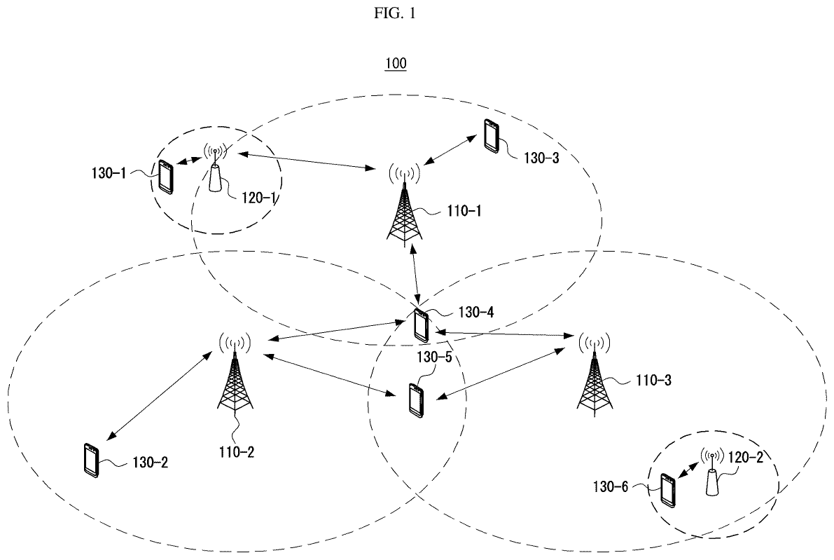

FIG. 1 is a conceptual diagram illustrating an exemplary embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. The plurality of communication nodes may support 4th generation (4G) communication (e.g., long term evolution (LTE), LTE-advanced (LTE-A)), 5th generation (5G) communication (e.g., new radio (NR)), or the like. The 4G communication may be performed in a frequency band of 6 gigahertz (GHz) or below, and the 5G communication may be performed in a frequency band of 6 GHz or above.

For example, for the 4G and 5G communications, the plurality of communication nodes may support a code division multiple access (CDMA) based communication protocol, a wideband CDMA (WCDMA) based communication protocol, a time division multiple access (TDMA) based communication protocol, a frequency division multiple access (FDMA) based communication protocol, an orthogonal frequency division multiplexing (OFDM) based communication protocol, a filtered OFDM based communication protocol, a cyclic prefix OFDM (CP-OFDM) based communication protocol, a discrete Fourier transform spread OFDM (DFT-s-OFDM) based communication protocol, an orthogonal frequency division multiple access (OFDMA) based communication protocol, a single carrier FDMA (SC-FDMA) based communication protocol, a non-orthogonal multiple access (NOMA) based communication protocol, a generalized frequency division multiplexing (GFDM) based communication protocol, a filter bank multi-carrier (FBMC) based communication protocol, a universal filtered multi-carrier (UFMC) based communication protocol, a space division multiple access (SDMA) based communication protocol, or the like.

In addition, the communication system 100 may further include a core network. When the communication system 100 supports the 4G communication, the core network may comprise a serving gateway (S-GW), a packet data network (PDN) gateway (P-GW), a mobility management entity (MME), and the like. When the communication system 100 supports the 5G communication, the core network may comprise a user plane function (UPF), a session management function (SMF), an access and mobility management function (AMF), and the like.

Meanwhile, each of the plurality of communication nodes 110-1, 110-2, 110-3, 120-1, 120-2, 130-1, 130-2, 130-3, 130-4, 130-5, and 130-6 constituting the communication system 100 may have the following structure.

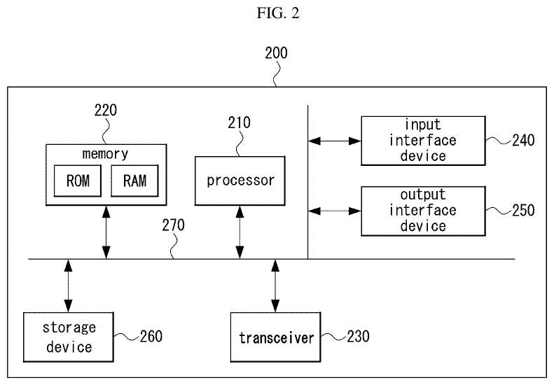

FIG. 2 is a block diagram illustrating an exemplary embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

However, each component included in the communication node 200 may be connected to the processor 210 via an individual interface or a separate bus, rather than the common bus 270. For example, the processor 210 may be connected to at least one of the memory 220, the transceiver 230, the input interface device 240, the output interface device 250, and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. The communication system 100 including the base stations 110-1, 110-2, 110-3, 120-1, and 120-2 and the terminals 130-1, 130-2, 130-3, 130-4, 130-5, and 130-6 may be referred to as an ‘access network’. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to cell coverage of the first base station 110-1. Also, the second terminal 130-2, the fourth terminal 130-4, and the fifth terminal 130-5 may belong to cell coverage of the second base station 110-2. Also, the fifth base station 120-2, the fourth terminal 130-4, the fifth terminal 130-5, and the sixth terminal 130-6 may belong to cell coverage of the third base station 110-3. Also, the first terminal 130-1 may belong to cell coverage of the fourth base station 120-1, and the sixth terminal 130-6 may belong to cell coverage of the fifth base station 120-2.

Here, each of the plurality of base stations 110-1, 110-2, 110-3, 120-1, and 120-2 may refer to a Node-B, a evolved Node-B (eNB), a base transceiver station (BTS), a radio base station, a radio transceiver, an access point, an access node, a road side unit (RSU), a radio remote head (RRH), a transmission point (TP), a transmission and reception point (TRP), an eNB, a gNB, or the like.

Here, each of the plurality of terminals 130-1, 130-2, 130-3, 130-4, 130-5, and 130-6 may refer to a user equipment (UE), a terminal, an access terminal, a mobile terminal, a station, a subscriber station, a mobile station, a portable subscriber station, a node, a device, an Internet of things (IoT) device, a mounted apparatus (e.g., a mounted module/device/terminal or an on-board device/terminal, etc.), or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul or a non-ideal backhaul, and exchange information with each other via the ideal or non-ideal backhaul. Also, each of the plurality of base stations 110-1, 110-2, 110-3, 120-1, and 120-2 may be connected to the core network through the ideal or non-ideal backhaul. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

In addition, each of the plurality of base stations 110-1, 110-2, 110-3, 120-1, and 120-2 may support multi-input multi-output (MIMO) transmission (e.g., a single-user MIMO (SU-MIMO), multi-user MIMO (MU-MIMO), massive MIMO, or the like), coordinated multipoint (COMP) transmission, carrier aggregation (CA) transmission, transmission in an unlicensed band, device-to-device (D2D) communications (or, proximity services (ProSe)), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2, and operations supported by the plurality of base stations 110-1, 110-2, 110-3, 120-1, and 120-2. For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

The first base station 110-1, the second base station 110-2, and the third base station 110-3 may transmit a signal to the fourth terminal 130-4 in the CoMP transmission manner, and the fourth terminal 130-4 may receive the signal from the first base station 110-1, the second base station 110-2, and the third base station 110-3 in the CoMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

Hereinafter, random access methods in a wireless communication system will be described. Even when a method (e.g., transmission or reception of a data packet) performed at a first communication node among communication nodes is described, the corresponding second communication node may perform a method (e.g., reception or transmission of the data packet) corresponding to the method performed at the first communication node. That is, when an operation of a receiving node is described, a corresponding transmitting node may perform an operation corresponding to the operation of the receiving node. Conversely, when an operation of a transmitting node is described, a corresponding receiving node may perform an operation corresponding to the operation of the transmitting node.

In an exemplary embodiment of the communication system, a UE may access a base station or a cell formed by the base station. Here, for a cell search procedure performed by the UE, which is a procedure of acquiring synchronization with the cell, the base station may transmit a primary synchronization signal (PSS), a secondary synchronization signal (SSS), and the like in downlink. A plurality of PSSs in a synchronization signal block (SSB) within one cell may be the same or different from each other. The PSS of one cell may have one of three different values according to a physical layer cell ID of the cell. For example, three cell IDs within one cell ID group may correspond to different PSSs, respectively.

Meanwhile, the UE may request connection establishment with the cell or communication network through a procedure commonly referred to as ‘random access’. For example, the random access may be used for the following purposes.
A purpose of acquiring uplink synchronization at the time of initial access
A purpose of establishing a radio link through initial access (transition from RRC_IDLE state to RRC_CONNECTED state)
A purpose of re-establishing a radio link after a radio link failure
A purpose of acquiring uplink synchronization with a new cell in a handover procedure
A purpose of acquiring uplink synchronization when uplink or downlink data arrives, in case that the UE is in RRC_CONNECTED state but uplink synchronization is not acquired
A purpose of requesting scheduling when there is no designated scheduling request resource on a physical uplink control channel (PUCCH)
A purpose of performing an assignment procedure of a C-RNTI, which is a UE-specific identifier

The UE may inform the base station of a random access attempt by transmitting a random access (RA) preamble, and allow the base station to estimate a delay time between the UE and the base station (or a relative position or distance of the UE to the cell base station). The estimation of the delay time may be used to adjust an uplink timing so that uplink signals of all UEs are simultaneously received at the base station. In the random access, the RA preamble may be transmitted through a time-frequency resource such as a physical random access channel (PRACH). The base station or communication network may transmit information on which time-frequency resources are available for RA preamble transmission to UEs within the cell in a broadcast manner. In the random access procedure, the UE may select one preamble to be transmitted on the PRACH.

The length of a RA preamble region in the time domain may vary according to preamble configuration. In an exemplary embodiment of the communication system, a random access resource may be configured to have the length of 1 ms, but a longer RA preamble may be configured in some cases. An uplink scheduler of the base station may avoid scheduling UEs on a plurality of consecutive subframes, thereby leaving an arbitrarily long random access region.

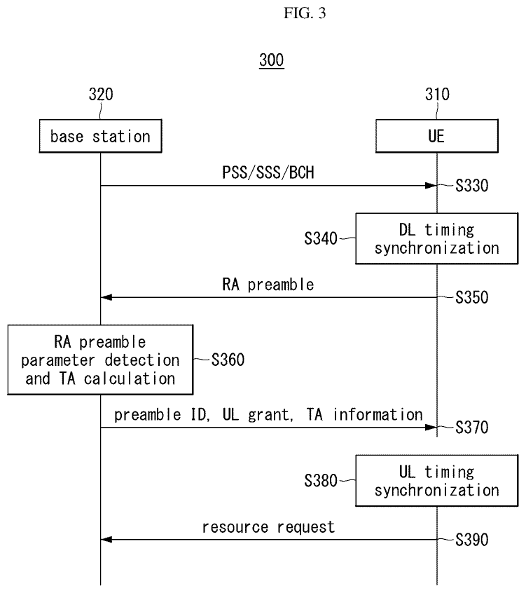

FIG. 3 is a sequence chart illustrating an exemplary embodiment of an RA procedure in a communication system.

Referring to FIG. 3, a communication system 300 according to the present disclosure may be the same as or similar to the communication system described with reference to FIG. 1. The communication system 300 may include one or more UEs 310 and a base station 320 to which the UE 310 accesses. The UE 310 may be the same as or similar to the terminals 130-1, 130-2, 130-3, 130-4, 130-5, and 130-6 described with reference to FIG. 1 or the communication node 200 described with reference to FIG. 2. The base station 320 may be the same as or similar to the base stations 110-1, 110-2, 110-3, 120-1, and 120-2 described with reference to FIG. 1 or the communication node 200 described with reference to FIG. 2. Hereinafter, an exemplary embodiment in which one UE 310 and one base station 320 performs an RA procedure through a random access channel will be described with reference to FIG. 3. However, this is only one example for convenience of description, and exemplary embodiments of the present disclosure are not limited thereto.

The UE 310 may be in a state of not being connected to a cell. The base station 320 may transmit synchronization information and/or system information to the UE 310 (S330). The synchronization information transmitted from the base station 320 to the UE 310 may be transmitted through synchronization signals. For example, the synchronization information may be transmitted through a synchronization signal block (SSB) composed of a primary synchronization signal (PSS) and a secondary synchronization signal (SSS). The system information transmitted from the base station 320 to the UE 310 may be transmitted through a system information block (SIB), SIBx, and/or master information block (MIB). The system information may be transmitted through a broadcast channel (BCH). However, this is only one example for convenience of description, and exemplary embodiments of the present disclosure are not limited thereto.

The UE 310 may receive the synchronization information and/or system information transmitted from the base station 320 in a cell search state (S330). The UE 310 may perform downlink (DL) timing synchronization based on the information transmitted from the base station 320 (S340). For example, the UE 310 may perform DL timing synchronization based on a timing at which the synchronization information and system information transmitted from the base station 320 are received.

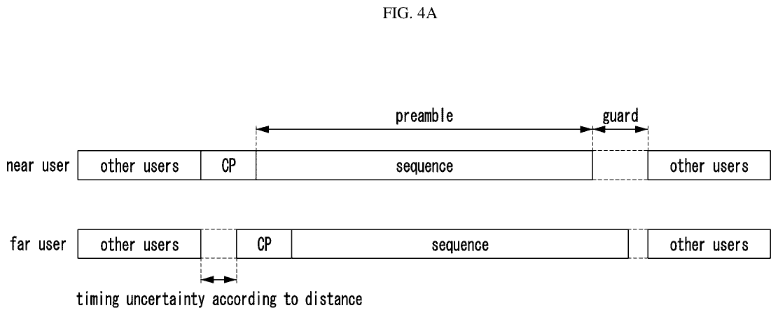

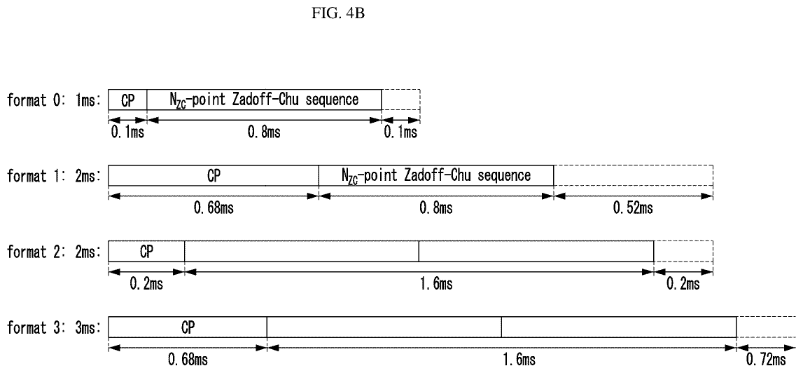

The UE 310 may generate an RA preamble (or RACH preamble) based on parameters included in the information transmitted from the base station 320. The UE 310 may transmit the generated RA preamble to the base station 320 (S350). An exemplary embodiment of the RA preamble transmitted from the UE 310 to the base station in the step S350 will be described in more detail with reference to FIGS. 4A and 4B.

The base station 320 may receive the RA preamble transmitted from the UE 310 (S350). The base station 320 may obtain an RA preamble sequence (or preamble sequence) from the RA preamble transmitted from the UE 310 (S360). The base station 320 may calculate a timing advance (TA) value based on the RA preamble transmitted from the UE 310 (S360). In other words, the base station 320 may estimate an uplink (UL) transmission timing of the UE 310 based on the RA preamble transmitted from the UE 310.

The base station 320 may generate an RA response (RAR) based on the RA preamble transmitted from the UE 310. The base station 320 may transmit the RAR to the UE 310 (S370). The RAR transmitted from the base station 320 to the UE 310 may include a preamble identifier (ID), UL grant, TA information, and the like.

The UE 310 may receive the RAR transmitted from the base station 320 (370). The UE 310 may perform UL timing synchronization based on the RAR transmitted from the base station 320 (S380). For example, the UE 310 may perform TA adjustment based on the TA information included in the RAR transmitted from the base station 320. In other words, the UE 310 may perform UL timing synchronization for adjusting a UL transmission timing based on the RAR transmitted from the base station 320. The UE 310 may request a resource to the base station 320 based on the UL transmission timing adjusted in the step S380 (S390). The UE 310 may perform communication with the base station 320 based on a resource allocated from the base station 320 according to the resource request in the step S390.

FIGS. 4A and 4B are conceptual diagrams for describing a first exemplary embodiment of an RA preamble structure in the communication system.

Referring to FIGS. 4A and 4B, a UE not connected to a cell (or base station) in the communication system may perform an RA procedure to access a cell (or base station). The UE may transmit an RA preamble to the base station in the RA procedure. Here, the UE and the base station may be the same as or similar to the UE 310 and the base station 320 described with reference to FIG. 3. The RA preamble transmitted by the UE to the base station in the RA procedure may be the same as or similar to the RA preamble described with reference to the step S350 of FIG. 3.

Referring to FIG. 4A, in an exemplary embodiment of the communication system, the RA preamble may include a cyclic prefix (CP), preamble sequence, and guard time (GT). Here, the preamble sequence may be configured as, for example, a Zadoff-Chu sequence. However, this is only one example for convenience of description, and exemplary embodiments of the communication system are not limited thereto.

Before starting the random access procedure, the terminal may acquire DL synchronization through the cell search procedure. Meanwhile, since the position of the UE within the cell is not known to the base station before UL synchronization is acquired, uncertainty may exist in an uplink timing. Here, the uncertainty of uplink timing may increase as the size of the cell increases. In order to consider the timing uncertainty and to avoid interference with subsequent subframes that are not used for the random access, the guard time (GT) may be used in transmitting the RA preamble. The GT may be arranged within each RA preamble or before/after the RA preamble in order to cope with the uncertainty of transmission timing that occurs variably according to a distance between the communication nodes.

For example, as described with reference to the steps S330 to S350 of FIG. 3, the UE may transmit the RA preamble to the base station in a state in which DL timing synchronization has been acquired based on information received from the base station. That is, the UE may transmit the RA preamble to the base station in a state in which UL timing synchronization has not yet been acquired. Accordingly, uncertainty may exist in the UL timing, and as the cell size increases, the uncertainty of the UL timing may also increase. In order to overcome such UL timing uncertainty and avoid interference with subframes located before and/or after the RA preamble, the GT may be arranged within each RA preamble or before/after the RA preamble. To this end, the length of the GT may be defined as a value greater than a sum of a multipath channel delay time and a round trip delay (RTD) time difference between a UE closest to the base station and a UE farthest from the base station.

Meanwhile, a cyclic prefix (CP) may be used in transmitting the RA preamble. Using this, low-complexity frequency domain processing may be possible at the base station. To this end, the length of the CP may need to be defined as a value larger than the RTD time difference between a UE closest to the base station and a UE farthest from the base station. The length of the CP may be set equal to or similar to the length of the GT.

Referring to FIG. 4B, the RA preamble may have one of a plurality of formats. The plurality of formats that the RA preamble may have may include, for example, a format 0, format 1, format 2, format 3, and the like shown in FIG. 4B. In the format 0, the lengths of CP and GT may be set to be equal to or similar to 0.1 ms, and the length of preamble sequence may be set to be equal to or similar to 0.8 ms. The format 0 may support up to a cell with a radius of 15 km. On the other hand, the formats 1, 2, and 3 may support up to cells with radiuses of 78 km, 30 km, and 100 km, respectively. In the formats 2 and 3, the same preamble sequence may be transmitted twice. This may be seen as a configuration for increasing an energy gain.

Meanwhile, in an exemplary embodiment of the communication system, a plurality of formats that the RA preamble may have may be the same as or similar to those shown in Table 1.

TABLE 1

| | Preamble | Subcarrier | | CP | Preamble length |
|---|---|---|---|---|---|
| | sequence | spacing | Number of | length | (us) |
| Format | length | (kHz) | repetitions | (us) | (excluding CP) |
| 0 | 839 | 1.25 | 1 | 103.12 | 800 |
| 1 | 839 | 1.25 | 2 | 684.37 | 1600 |
| 2 | 839 | 1.25 | 4 | 152.60 | 3200 |
| 3 | 839 | 5 | 4 | 103.12 | 800 |
| A1 | 139 | 15 | 2 | 9.37 | 133.33 |
| A2 | 139 | 15 | 4 | 18.75 | 266.67 |
| A3 | 139 | 15 | 6 | 28.12 | 400 |
| B1 | 139 | 15 | 2 | 7.03 | 133.33 |
| B2 | 139 | 15 | 4 | 11.71 | 266.67 |
| B3 | 139 | 15 | 6 | 16.41 | 400 |
| B4 | 139 | 15 | 12 | 30.47 | 800 |
| C0 | 139 | 15 | 1 | 40.36 | 66.67 |
| C2 | 139 | 15 | 4 | 66.67 | 266.67 |

The formats 0 to 3 shown in FIG. 4B or the formats shown in Table 1 may be formats determined based on terrestrial networks. As such, the RA preamble formats determined based on terrestrial networks may not be easy to support a cell having a scale exceeding 100 km in radius. In other words, the RA preamble formats determined based on terrestrial networks may not be suitable for use in the RA procedure in the NTN cell.

The NTN may include satellites such as low earth orbit (LEO), medium earth orbit (MEO), or geostationary earth orbit (GEO) satellites. The NTN may have a larger Doppler shift, wider cell coverage, and tighter power limitations than terrestrial networks. For example, in an exemplary embodiment of the communication system, the NTN may include LEO satellites traveling at a speed of 7.5 km/s or higher, in which case a Doppler shift of 20 ppm or more may occur. Alternatively, the NTN may have a cell size of 100 km or more in radius, such as a GEO satellite cell with a cell radius of about 1000 km or a LEO satellite cell with a cell radius of 200 km or more.

Meanwhile, the base station may configure a longer GT (or CP) than the GT (or CP) proposed in the above-described formats. For example, the base station may configure a longer GT (or CP) by not scheduling any uplink transmission in a subframe following the last RA resource.

In the NTN, an RTD time difference between UEs may exceed the length of CP. Accordingly, a frequency domain processing may not be performed through one observation window (or fast Fourier transform (FFT) window), and a time domain processing may need to be performed through a plurality of observation windows. As a result, complexity of a receiving end or a receiver may be increased and a preamble acquisition time may be increased.

In the communication network such as NTN, an RA technique capable of low-complexity frequency domain processing while maintaining compatibility with the RA procedure determined based on terrestrial networks may be required.

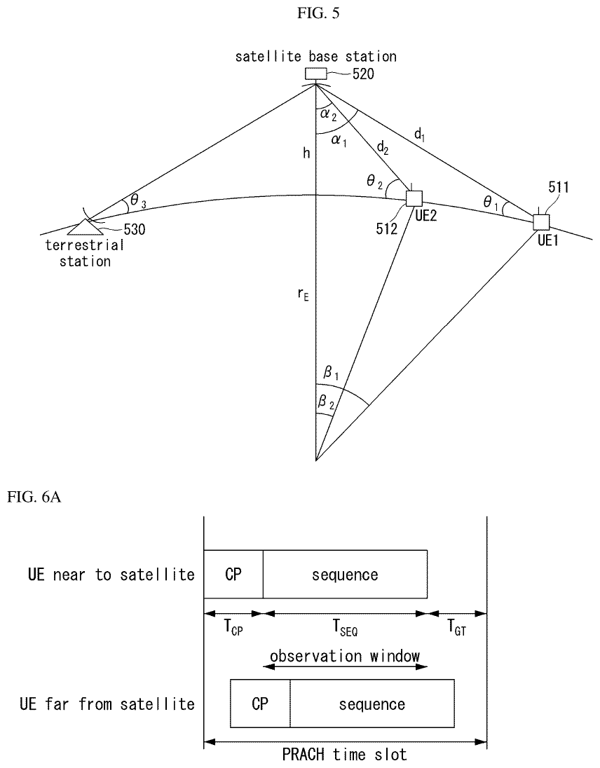

FIG. 5 is a conceptual diagram for describing propagation delays according to locations of satellites and terminals constituting an NTN in an exemplary embodiment of a communication system.

Referring to FIG. 5, a communication system 500 may include an NTN. The communication system 500 may include one or more UEs 511 and 512, one or more satellite base stations 520 to which the UEs 511 and 512 access, and a ground (or terrestrial) station (e.g., terrestrial gateway, terrestrial base station, local earth station (LES), etc.) 530, and the like. The parameters shown in FIG. 5 may be defined as follows.
h: satellite base station altitude (i.e., satellite height)
r_{E}: Earth radius
dᵢ: distance between a satellite base station and each UE (satellite-terminal distance)
α₁: angle at which each UE is located with respect to a vertical plane from a satellite base station
βᵢ: angle at which each UE is located with respect to a vertical plane from a center of the earth
θᵢ: elevation angle at each UE or terrestrial station

Here, a difference Δt_{1,2} between propagation delay times tᵢ for the respective UEs 511 and 512 may be defined as in Equation 1.

$$Δ {t}_{1 , 2} = {t}_{1} - {t}_{2} \qquad [ Equation 1 ]$$

Here, tᵢ may be defined as Equation 2 based on a speed of light c.

$${t}_{i} = \frac{{d}_{i}}{c} \qquad [ Equation 2 ]$$

$${d}_{i} = \sqrt{{r}_{E}^{2} + {( {r}_{E} + h )}^{2} - 2 {r}_{E} ( {r}_{E} + h ) cos {β}_{i}}$$

$${β}_{i} = arc cos ( \frac{{r}_{E}}{{r}_{E} + h} cos {θ}_{i} ) - {θ}_{i}$$

That is, the difference Δt_{1,2} between propagation delay times tᵢ for the respective UEs 511 and 512 in the communication system 500 may be determined based on the satellite altitude, elevation angle, beam coverage, and the like. For example, in an exemplary embodiment of the communication system 500, the length of RA preamble and/or the length of CP for the NTN may need to be set to 3.26 ms or more.

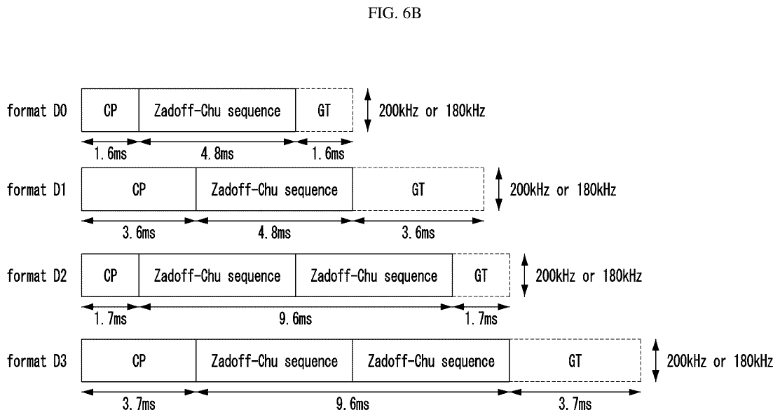

FIGS. 6A and 6B are conceptual diagrams for describing a second exemplary embodiment of an RA preamble structure in the communication system.

Referring to FIGS. 6A and 6B, in a communication system, a UE may perform an RA procedure to access a cell (or base station). The UE may transmit an RA preamble to the base station in the RA procedure. Here, the communication system may include an NTN. The UE and the base station may be the same as or similar to the UEs 511 and 512 and the satellite base station 520 described with reference to FIG. 5. A terrestrial network and the NTN may coexist in the communication system. When a radius of the cell to which the UE intends to access is 100 km or less, the RA procedure may be performed based on one of the RA preamble formats described with reference to FIG. 4B. On the other hand, when the radius of the cell to which the UE intends to access exceeds 100 km, the UE may generate an RA preamble having a structure described with reference to FIGS. 6A and 6B in the RA procedure, and transmit it to the base station.

Referring to FIG. 6A, in an exemplary embodiment of the communication system, the RA preamble may include a CP, preamble sequence, and GT. In the time domain, the CP may have a length equal to T_{CP}, the preamble sequence may have a length equal to T_{SEQ}, and the GT may have a length equal to T_{GT}. A period in which the preamble sequence is arranged in the time domain may be referred to as an ‘observation window’. The observation window may be fixed in the time domain for one-shot detection. For example, the base station performing the RA procedures with UEs may obtain preamble sequences included in RA preambles transmitted by the UEs through monitoring on the fixed observation window for one-shot detection.

Referring to FIG. 6B, the RA preamble may have one of a plurality of formats. The plurality of formats that the RA preamble may have may include, for example, a format D0, format D1, format D2, format D3, and the like shown in FIG. 6B. Here, the RA preambles of the formats D0 to D3 may have a bandwidth of 200 kHz or 180 kHz in the frequency domain. The RA preamble of the format D0 may have a length of 8 ms in the time domain, the lengths of CP and GT therefor may each be 1.6 ms, and the length of preamble sequence therefor may be 4.8 ms. The RA preamble of the format D1 may have a length of 12 ms, the lengths of CP and GT therefor may each be 3.6 ms, and the length of preamble sequence therefor may be 4.8 ms. The RA preamble of the format D2 may have a length of 13 ms, the lengths of CP and GT therefor may each be 1.7 ms, and the length of preamble sequence therefor may be 9.6 ms. The RA preamble of the format D3 may have a length of 17 ms, the lengths of CP and GT therefor may each consist of 3.7 ms, and the length of preamble sequence therefor may be 9.6 ms. For example, the formats D0 to D3 may be configured identically or similarly to those shown in Table 2.

TABLE 2

| Preamble format | T_{CP} | T_{SEQ} |
|---|---|---|
| D0 | 8 × 6240Ts (1.6 ms) | 6 × 24576Ts (4.8 ms) |
| D1 | 18 × 6240Ts (3.6 ms) | 6 × 24576Ts (4.8 ms) |
| D2 | 8 × 6240Ts (1.6 ms) | 12 × 24576Ts (9.6 ms) |
| D3 | 18 × 6240Ts (3.6 ms) | 12 × 24576Ts (9.6 ms) |

In Table 2, Ts may mean a sampling period. For example, Ts may have a value of T_{S}=1/(15000X2048). Each of the preamble sequences of the formats D0 and D1 may be configured as, for example, a Zadoff-Chu sequence generated based on a root u and having a size of 839. On the other hand, each of the preamble sequences of the formats D2 and D3 may be configured such that a Zadoff-Chu sequence generated based on a root u and having a size of 839 is repeated twice. However, this is only an example for convenience of description, and exemplary embodiments of the communication system are not limited thereto. For example, in each RA preamble format, the preamble sequence may be configured as a sequence other than the Zadoff-Chu sequence.

In order for the RA preamble structure supporting NTN, which is described with reference to FIGS. 6A and 6B, to maintain orthogonality for preventing from causing interference between networks while maintaining compatibility with the RA preamble structure supporting terrestrial networks, which is described with reference to FIGS. 4A and 4B, or a data transport block structure, a multiplexing scheme such as Equation 3 may be applied.

$${n}_{PRB}^{RA} = \{ \begin{matrix}{n}_{PRB offset}^{RA} + 2 \vert \frac{{f}_{RA}}{2} \vert , & if {f}_{RA} mod 2 = 0 , \\ {N}_{RB}^{UL} - 2 - {n}_{PRB offset}^{RA} - 2 \vert \frac{{f}_{RA}}{2} \vert , & otherwise ,\end{matrix} \qquad [ Equation 3 ]$$

In Equation 3,

$${N}_{RB}^{UL}$$

may refer to the number of RBs for UL transmission, and

$${n}_{PRB}^{RA}$$

may refer to the number of resource blocks (RBs) or physical resource blocks (PRBs) initially allocated for the RA procedure.

$${n}_{PRB}^{RA}$$

_{offset} may be defined based on a configuration parameter defined by a higher layer or Equation 4.

$$0 \leq {n}_{PRB offset}^{RA} \leq {N}_{RB}^{UL} - 1 \qquad [ Equation 4 ]$$

The RA preamble structure for NTN, which is described with reference to FIG. 6B, may require compatibility with the RA preamble structure for terrestrial networks, which is described with reference to FIG. 4B. To this end, a size of a bandwidth occupied in the frequency domain by the RA preamble structure for NTN, which is described with reference to FIG. 6B, may be set to correspond to (1/n) of a size of a bandwidth occupied by the RA preamble structure for terrestrial networks, which is described with reference to FIG. 4B. Here, n may be 6, but this is only an example for convenience of description, and exemplary embodiments of the communication system are not limited thereto. For this configuration, the RA preamble (or RACH signal) may be generated as shown in Equation 5.

$$s ( t ) = {β}_{PRACH} \text{} {\sum }_{k = 0}^{{N}_{ZC - 1}} {\sum }_{n = 0}^{{N}_{ZC - 1}} {x}_{u , v} ( \text{} n ) \cdot \text{} {e}^{- j \frac{2 π nk}{{N}_{ZC}}} \cdot \text{} {e}^{j 2 π ( k + ϕ + K ( {k}_{0} + 1 / 2 ) ) Δ {f}_{RA} ( t - {T}_{CP} )} \qquad [ Equation 5 ]$$

In Equation 5, t may be defined as 0≥t<T_{SEQ}+T_{CP}. β_{PRACH} may correspond to a scaling factor for determining a transmit power. x_{u,v}(n) may correspond to the RA preamble sequence. k₀ may be defined as

$${n}_{PRB}^{RA} {N}_{sc}^{RB} - {N}_{RB}^{UL} {N}_{sc}^{RB} / 2 or 12 + {n}_{PRB}^{RA} {N}_{sc}^{RB} - {N}_{RB}^{UL} {N}_{sc}^{RB} / 2.$$

The location of the RA preamble (or RACH signal) in the frequency domain as shown in Equation 5 may be determined by the parameter n_{PRB}^{RA}. K may represent a difference or ratio between a subcarrier spacing (SCS) (Δf_{RA}) for RA and an SCS (Δf) for UL data transmission. For example, K may be defined as K=Δf/Δf_{RA}. ϕ may correspond to an offset value indicating the location of the RA preamble in the frequency domain. Values such as Δf_{RA}, ϕ, and K may be defined as values for maintaining orthogonality so that interference does not occur between the networks. For example, in an exemplary embodiment of the communication system, values of Δf_{RA}, ϕ, and K may be defined as shown in Table 3.

TABLE 3

| Preamble format | Δf_{RA} | ϕ | K |
|---|---|---|---|
| DO~D3 | 208.33 Hz | −12 | 72 |

The configuration parameters described with reference to FIGS. 6A, 6B, and Table 3 are merely examples for convenience of description, and exemplary embodiments of the communication system are not limited thereto.

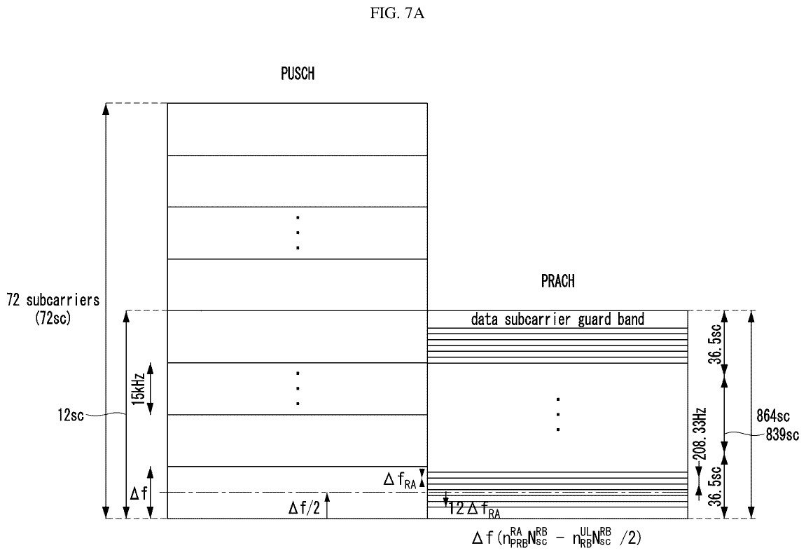

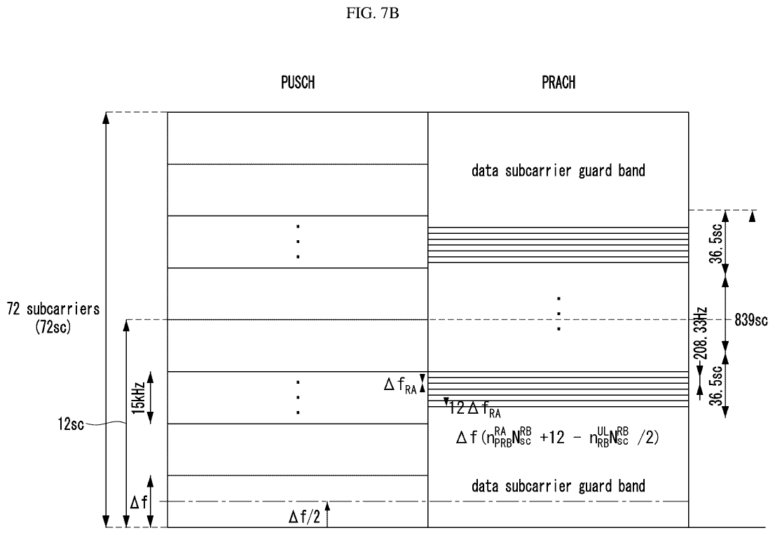

FIGS. 7A and 7B are conceptual diagrams for describing an exemplary embodiment of a method of mapping an RA preamble in the frequency domain in the communication system.

Referring to FIGS. 7A and 7B, in an exemplary embodiment of the communication system, an RA preamble transmitted from a UE to a base station through a physical random access channel (PRACH) may be mapped in the frequency domain in a scheme different from that for a physical uplink shared channel (PUSCH) transmitted from the UE to the base station. Alternatively, it may be mapped in the frequency domain in the same or similar manner to that shown in FIGS. 7A and/or 7B.

Referring to FIG. 7A, an SCS of PUSCH and an SCS of PRACH may be set to have an integer multiple relationship. For example, the SCS of PUSCH may be 72 times the SCS of PRACH. In other words, the SCS of PRACH may be set to have a value of 1/72 of the SRS of PUSCH. This may correspond to a case where K is set to 72 in Table 3. In this case, 12 subcarriers occupy a bandwidth of 180 kHz in a PUSCH, while 864 subcarriers occupies a bandwidth of 180 kHz in a PRACH. Here, in order to reduce the effect of interference, a guard band corresponding to a predetermined bandwidth may be disposed at the upper and/or lower ends of the PRACH in the frequency domain. For example, a guard band corresponding to (1/n) (n is an integer) of the size of the PUSCH subcarriers may be disposed at the upper end and/or lower end of the PRACH.

Expressing the exemplary embodiment shown in FIG. 7A differently, the size of the total bandwidth occupied by the PRACH used in the RA procedure in NTN may be set to correspond to (1/6) of the size of the total bandwidth (e.g., 1080 KHz) occupied by the PUSCH or the PRACH used in the RA procedure in terrestrial networks.

Referring to FIG. 7B, the SCS of PRACH may be set to have a value of (1/36) of the SCS of PUSCH as in FIG. 7A. Here, a guard band may be disposed in a wider band than in FIG. 7A at the upper and/or lower end of the PRACH so that the PRACH and the PUSCH occupy the same bandwidth. For example, in the PUSCH, 72 subcarriers occupy a bandwidth of 1080 kHz, and in the PRACH, 864 subcarriers including 839 subcarriers corresponding to the preamble sequence and guard band(s) disposed in the upper and/or lower end of the PRACH occupy a bandwidth of 1080 kHz.

As described with reference to FIGS. 7A and 7B, the SCS (or bandwidth) applied to the RA procedure and the SCS (or bandwidth) applied to data transmission such as PUSCH may be set to have an integral multiple relationship. Through this, the same (or compatible) FFT block, IFFT block, band filter, etc. may be used in different networks or different procedures (RA procedure, data transmission, etc.). In addition, since the terminal can perform transmission with a higher power per a unit bandwidth in this case, a large link margin can be secured.

In addition, the size of the remaining bandwidth generated through the frequency domain mapping as shown in FIG. 7A may have an integer multiple relationship with the size of one bandwidth for a data channel such as PUSCH. In addition, since the bandwidth size decreases instead of increasing the sequence length, time-frequency resources required for the RA procedure may not increase even though the RTD time increases. Through this, compatibility between resource scheduling operations for different networks or different procedures (RA procedures, data transmission, etc.) may be maintained.

In an exemplary embodiment of the communication system, the RA preamble may be arranged in the time domain as described with reference to FIGS. 6A and 6B and in the frequency domain as described with reference to FIGS. 7A and 7B. In this case, an RA coverage may be extended by increasing a transmit power density for the RA preamble. Meanwhile, in order to guarantee RA performance in some NTN environments in which a Doppler shift has a large effect, an RA technique capable of effectively detecting a delay time may be required even in a situation where a Doppler shift is large.

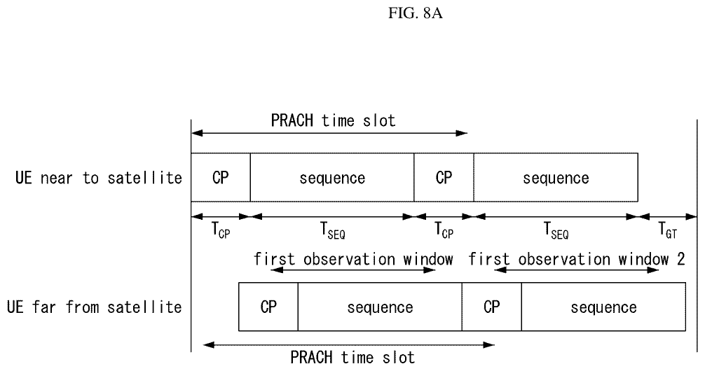

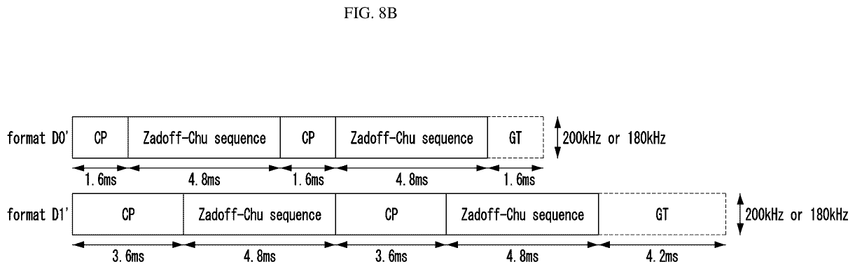

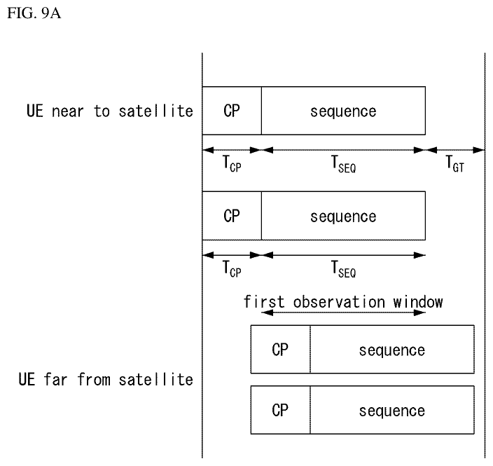

FIGS. 8A and 8B are conceptual diagrams for describing a third exemplary embodiment of an RA preamble structure in the communication system.

Referring to FIGS. 8A and 8B, in the communication system, a UE may perform an RA procedure to access a cell (or base station). The UE may transmit an RA preamble to the base station in the RA procedure. Here, the communication system may include an NTN. The UE and the base station may be the same as or similar to the UEs 511 and 512 and the satellite base station 520 described with reference to FIG. 5. A terrestrial network and the NTN may coexist in the communication system. The UE may generate an RA preamble having a structure described with reference to FIGS. 8A and 8B in the RA procedure, and transmit it to the base station.

In an exemplary embodiment of the communication system, the RA preamble may consist of one or more CPs, one or more preamble sequences, one or more GTs, and the like. In the time domain, each CP may have a length equal to TCP, each preamble sequence may have a length equal to TSEQ, and each GT may have a length equal to TGT. A period in which the preamble sequence is arranged in the time domain may be referred to as an ‘observation window’.

Referring to FIG. 8A, in an exemplary embodiment of the communication system, one RA preamble may include two CPs, two preamble sequences, and one GT. Periods in which two preamble sequences are arranged in the time domain may be referred to as a ‘first observation window’ and a ‘second observation window’, respectively. The first and second observation windows may be fixed in the time domain for one-shot detection. For example, a base station performing RA procedures with the UEs may obtain two preamble sequences included in an RA preamble transmitted by each UE through monitoring in the fixed first and second observation windows for one-shot detection. The base station may detect the preamble in the frequency domain of each of the first observation window and the second observation window shown in FIGS. 5A and 5B in an one-shot detection scheme.

Referring to FIG. 8B, the RA preamble may have one of a plurality of formats. A plurality of formats that the RA preamble may have may include, for example, a format D0′ and a format D1′ shown in FIG. 8B. Here, RA preambles such as the format D0′ and the format D1′ may have a bandwidth of 200 kHz or 180 kHz in the frequency domain. The RA preamble of format D0′ may have a length of 15 ms in the time domain, the lengths of two CPs therefor may be 1.6 ms each, the lengths of two preamble sequences therefor may be 4.8 ms each, the length of GT therefor may be 2.2 ms. The RA preamble of format D1′ may have a length of 21 ms, the lengths of two CPs therefor may be 31.6 ms each, the lengths of two preamble sequences therefor may be 4.8 ms each, and the length of GT therefor may be 4.2 ms.

In the format D0′ and format D1′, the two preamble sequences constituting the RA preamble may be defined as different sequences. For example, the RA preamble may be configured to include a first preamble sequence and a second preamble sequence that are Zadoff-Chu sequences each having a size of 839. Here, the first preamble sequence may be generated based on a root u, and the second preamble sequence may be generated based on a root w. By configuring the RA preamble to include two different preamble sequences having the same structure, the performance of delay time detection at the base station receiving the RA preamble may be improved. For example, since preambles having the same structure, which are composed of Zadoff-Chu sequences having different root values, are simultaneously transmitted and received, delay time detection may be easily performed even in a situation where a relatively large Doppler shift occurs.

When a frequency axis position of a preamble sequence observed in the first observation window is P1 and a frequency axis position of a preamble sequence observed in the second observation window is P2, P1 and P2 may be expressed as Equation 6.

$$\begin{matrix}P 1 = D + UP , P 2 = D + UQ \\ U = \frac{{F}_{residual offset}}{Δ {f}_{RA}} , ( P \times u ) mod 839 = ( Q \times w ) mod 839 = 1\end{matrix} \qquad [ Equation 6 ]$$

In this case, the delay time detection may be easily performed even when a frequency shift occurs as shown in Equation 7 below.

$$\begin{matrix}D = \{ ( P 1 + P 2 - UP - UQ ) mode 839 \} / 2 \\ {F}_{residual offset} = \{ \frac{( P 1 - P 2 )}{( P - Q )} \} mod 839 / Δ {f}_{RA}\end{matrix} \qquad [ Equation 7 ]$$

When different preambles (or preamble sequences) are generated using Zadoff-Chu sequences based on different root values, a mapping relationship between the different root values may need to be additionally established. For example, when two preamble sequences are generated based on two different root values as shown in FIGS. 8A and 8B, a scheme in which the root value of the second preamble sequence is defined based on the root value of the first preamble sequence in consideration of compatibility between the networks may be used.

When the root w of the second preamble sequence is set to a value obtaining by inversing a polarity of the root value u of the first preamble sequence (i.e., w=−u), the complexity of calculation for detecting a delay time may be reduced as shown in Equation 8, and it may be easy to maintain compatibility.

$$\begin{matrix}D = \{ ( P 1 + P 2 ) mode 839 \} / 2 \\ {F}_{residual offset} = \frac{\{ ( P 1 - P 2 ) mod 839}{2} / Δ {f}_{RA}\end{matrix} \qquad [ Equation 8 ]$$

In Equations 6 to 8, 839 is only a numerical value presented as an example for convenience of description, and the third exemplary embodiment of the RA preamble structure is not limited thereto. For example, in Equations 6 to 8, 839 may be replaced with another value corresponding to a sequence length.

In FIGS. 8A and 8B, the CP may be arranged between the first preamble sequence and the second preamble sequence. In the case of NTN, since a cell radius is large, the number of UEs simultaneously attempting RA for one base station may be greater than in terrestrial mobile communication, and accordingly, a frequency of collisions between RA preambles may be relatively high. By disposing the CP between the first preamble sequence and the second preamble sequence, a possibility of collision between RA preambles may be lowered, a probability of false alarm or mis-detection may be lowered, and the performance of RA procedures may be improved. However, this is only an example for convenience of description, and exemplary embodiments of the communication system are not limited thereto. For example, in another exemplary embodiment of the communication system, the CP may not be arranged between the first preamble sequence and the second preamble sequence to save resources used for the RA procedure.

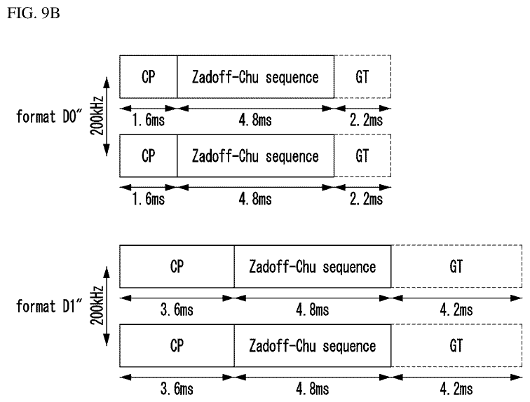

FIGS. 9A and 9B are conceptual diagrams for describing a fourth exemplary embodiment of an RA preamble structure in the communication system.

Referring to FIGS. 9A and 9B, in the communication system, a UE may perform an RA procedure to access a cell (or base station). The UE may transmit an RA preamble to the base station in the RA procedure. Here, the communication system may include an NTN. The UE and the base station may be the same as or similar to the UEs 511 and 512 and the satellite base station 520 described with reference to FIG. 5. A terrestrial network and the NTN may coexist in the communication system. The UE may generate an RA preamble having a structure described with reference to FIGS. 9A and 9B in the RA procedure, and transmit it to the base station. Hereinafter, in describing the fourth exemplary embodiment of the RA preamble structure with reference to FIGS. 9A and 9B, descriptions overlapping with those described with reference to FIGS. 1 to 8B may be omitted.

Referring to FIG. 9A, in transmitting an RA preamble once in an exemplary embodiment of the communication system, a UE may simultaneously transmit a plurality of CP-preamble sequence pairs having the same structure in the frequency domain. FIG. 9A shows an exemplary embodiment in which the UE simultaneously transmits two CP-preamble sequence pairs having the same structure in the frequency domain. However, this is only an example for convenience of description and exemplary embodiments of the communication system are not limited thereto.

Referring to FIG. 9B, an RA preamble may have one of a plurality of formats. A plurality of formats that the RA preamble may have may include, for example, a format D0″ and a format D1″ shown in FIG. 9B. In the format D0″ and format D1″, two preamble sequences constituting an RA preamble may be defined as different sequences. For example, the RA preamble may be configured to simultaneously include a first preamble sequence and a second preamble sequence, each of which is a Zadoff-Chu sequence and has a size of 839, generated based on roots u and w, respectively, in the frequency domain. Alternatively, the UE may operate to simultaneously transmit a first RA preamble including the first preamble sequence and a second RA preamble including the second preamble sequence to the base station through distinct and contiguous frequency resources. In this manner, the UE may simultaneously transmit a CP-preamble sequence pair having the same structure and including two different preamble sequences to the base station through different frequency resources, thereby improving the performance of detecting a delay time at the base station receiving the RA preamble.

Unlike the third exemplary embodiment of the RA preamble structure described with reference to FIGS. 8A and 8B, in the fourth exemplary embodiment of the RA preamble structure described with reference to FIGS. 9A and 9B, a plurality of preamble sequences (or preambles) may be transmitted together in the frequency domain rather than the time domain. In this case, since the period of GT can be reduced compared to the third exemplary embodiment of the RA preamble structure, a resource period for the RA procedure may be reduced. Through this, the capacity of the system may be increased.

Meanwhile, unlike the third exemplary embodiment of the RA preamble structure, the fourth exemplary embodiment of the RA preamble structure may have an advantage in which the base station can detect the preamble(s) and the delay time in the frequency domain by using only one fixed observation window in the one-shot detection scheme. However, in this case, the base station may need to use a plurality of narrowband filters to simultaneously receive a plurality of (e.g., two) preamble sequences in the same time resource, and the terminal may need to simultaneously transmit the two preamble sequences using different frequencies, and accordingly, a communication performance degradation such as Peak-to-Average Power Ratio (PAPR) performance degradation may occur. However, in this case, even when a PAPR performance degradation of 3 dB occurs, a performance gain of 7 dB or more may occur due to the narrowband transmission, and the overall communication performance may be improved. Based on a communication environment or performance conditions of communication nodes, one of the third and fourth exemplary embodiments of the RA preamble structure may be selectively applied.

According to the fourth exemplary embodiment of the RA preamble structure, with respect to each UE, a frequency axis position of the first preamble sequence observed in the first observation window may be defined as P1, and a frequency axis position of the second preamble sequence observed in the first observation window may be defined as P2. In this case, P1 and P2 may be determined identically or similarly to one of Equations 6 to 8.

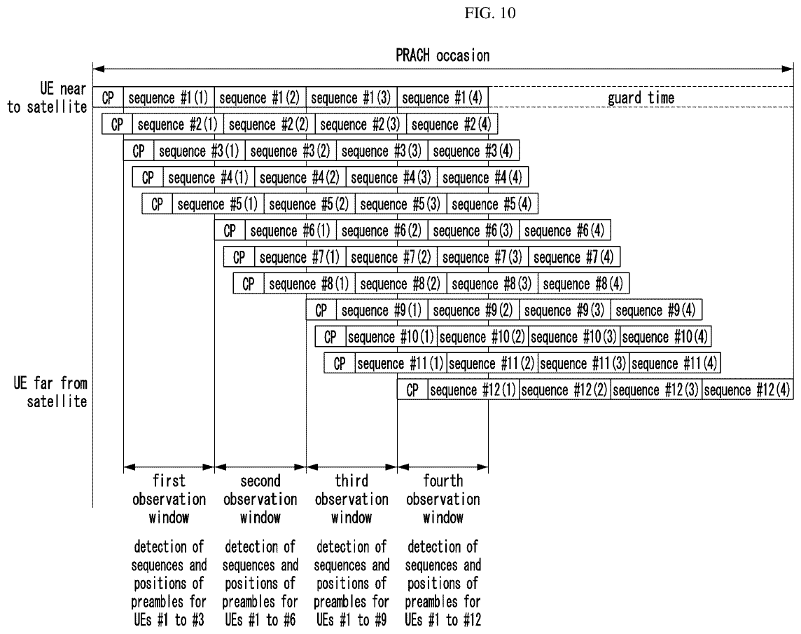

FIG. 10 is a conceptual diagram for describing a fifth exemplary embodiment of an RA preamble structure in the communication system.

Referring to FIG. 10, in the communication system, a UE may perform an RA procedure to access a cell (or base station). The UE may transmit an RA preamble to the base station in the RA procedure. Here, the communication system may include an NTN. The UE and the base station may be the same as or similar to the UEs 511 and 512 and the satellite base station 520 described with reference to FIG. 5. A terrestrial network and the NTN may coexist in the communication system. The UE may generate an RA preamble having a structure described with reference to FIG. 10 in the RA procedure, and transmit it to the base station. Hereinafter, in describing the fifth exemplary embodiment of the RA preamble structure with reference to FIG. 10, descriptions overlapping with those described with reference to FIGS. 1 to 9B may be omitted.

In an exemplary embodiment of the communication system, a GEO satellite system may form a cell having a radius of 500 km or more (e.g., 1000 km, 2000 km, etc.) by using a global beam. In such a wide-scaled cell, an RTD time difference between UEs may be large. When an RTD time difference between UEs is greater than a size of a CP of an RA preamble, it may not be easy to detect the RA preamble in one-shot in the frequency domain through a fixed window. In order to detect the RA preamble based on a non-fixed (i.e., moving) window for resolving the above- described problem, the complexity of a receiver may increase and a time required to perform the RA preamble detection operation may become longer, thereby increasing the amount of computation and computing power required for processing.

In an exemplary embodiment of the communication system, a method of detecting an RA preamble by configuring a plurality of fixed windows existing at CP intervals using any one of the RA preamble structures described with reference to FIGS. 4A to 9B may be used. In the above-described RA preamble detection scheme, if the CP length is small, the number of fixed windows requiring processing may increase, but resources for the entire RA operation may be reduced. Therefore, a criterion for properly determining the CP length may be required in consideration of implementation complexity and resource use efficiency.

In the fifth exemplary embodiment of the RA preamble structure shown in FIG. 10, an extended CP having an extended length corresponding to an RTD time difference between UEs may be configured. The length of the extended CP may be set based on an integer multiple of the length of CP or the length of preamble sequence in one of the exemplary embodiments of the RA preamble structure described with reference to FIGS. 4A to 9B. By setting the length of the extended CP in the above-described manner, the preamble sequence and the CP in at least one of the exemplary embodiments of the RA preamble structure described with reference to FIGS. 4A to 9B may be used identically or similarly. Accordingly, a small change may be required in implementation of the communication node, and the compatibility of the communication system may be maintained high.

In an exemplary embodiment of the communication system, the shorter the length of RA preamble, the more robust it can be to a Doppler shift. Meanwhile, in order to support the same RTD time difference as a long RA preamble, a short RA preamble may need to be composed of preamble sequences that are repeated (or repeated) more times than the long RA preamble.

Specifically, TCP_EXT, the length of the extended CP corresponding to an RTD time difference between UEs, may be defined identically or similarly to Equation 9.

$${T}_{CP \_ EXT} = ( N - 1 ) \times ( {T}_{SEQ} ) + {T}_{CP} \qquad [ Equation 9 ]$$

In Equation 9, T_{SEQ} may refer to the length of preamble sequence in one of the exemplary embodiments of the RA preamble structure described with reference to FIGS. 4A to 9B. T_{CP} may refer to the length of CP in one of the exemplary embodiments of the RA preamble structure described with reference to FIGS. 4A to 9B. N may refer to the number of required fixed windows. The length of the extended CP, T_{CP_EXT}, may be determined as a sum of the length of TCP and the length of the preamble sequences each having the length of T_{SEQ} which are repeated N−1 times. N may be determined as in Equation 10.

$$N = ( integer \text{} equal \text{} to \text{} or greater \text{} than ( \text{} ( {T}_{RTD \_ MAX} - {T}_{CP} ) \text{} / \text{} ( {T}_{SEQ} ) ) ) + 1 \qquad [ Equation 10 ]$$

T_{RTD_MAX} may refer to the maximum RTD time difference between UEs supported by the communication system or satellite system. FIG. 10 shows an exemplary embodiment in which N is 4. That is, the maximum RTD time between UEs supported by the system may be greater than or equal to the extended CP length T_{CP_EXT}. The length of T_{CP_EXT} may be equal to the total length of one CP having the length of TCP and three preamble sequences each having the length of T_{SEQ}. That is, T_{RTD_MAX}≥T_{CP_EXT}=3(T_{SEQ})+T_{CP} may be established. However, this is only an example for convenience of description, and the fifth exemplary embodiment of the RA preamble structure in the communication system are not limited thereto.

In the exemplary embodiment shown in FIG. 10, the base station may receive a plurality of RA preambles transmitted by a plurality of UEs (e.g., UE #1 to UE #12) in a PRACH occasion. Here, time points at which the plurality of RA preambles arrive at the base station may be determined differently according to distances between the plurality of UEs and the base station.

The RA preamble transmitted by each UE (e.g., UE #i) includes one CP having the length of TCP and a plurality of (e.g., 4) preamble sequences (i.e., #i(1) to #i(4)) each having the length of T_{SEQ}. Here, the repeated preamble sequences may be configured identically to each other. Alternatively, the repeated preamble sequences may be defined based on different root values identically or similarly to the third exemplary embodiment of the RA preamble structure shown in FIG. 8B.

The base station may perform RA preamble detection in first to fourth observation windows. The base station may detect sequences and positions of the RA preambles transmitted from the UEs #1 to #3 in the first observation window. The base station may detect sequences and positions of the RA preambles transmitted from the UEs #1 to #6 in the second observation window. The base station may detect sequences and positions of the RA preambles transmitted from the UEs #1 to #9 in the third observation window. The base station may detect sequences and positions of the RA preambles transmitted from the UEs #1 to #12 in the fourth observation window.

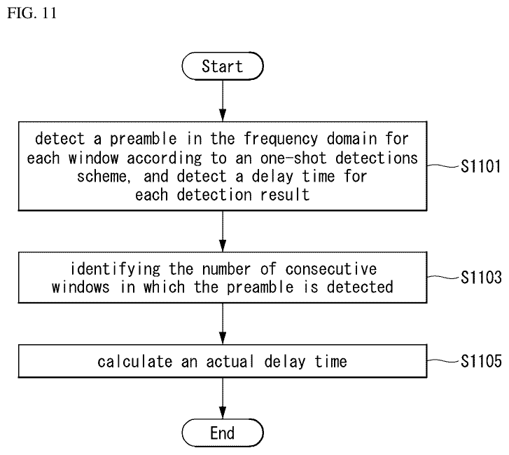

FIG. 11 is a conceptual diagram for describing an exemplary embodiment of a delay time calculation method according to the fifth exemplary embodiment of the RA preamble structure in the communication system.

Referring to FIG. 11, in the communication system, a UE may perform an RA procedure to access a cell (or base station). The UE may transmit an RA preamble to the base station in the RA procedure. Here, the communication system may include an NTN. The communication system may be the same as or similar to the communication system described with reference to FIG. 10. The UE and base station may be the same as or similar to the UE and base station described with reference to FIG. 10. Hereinafter, in describing an exemplary embodiment of a delay time calculation method according to the fifth exemplary embodiment of the RA preamble structure with reference to FIG. 11, descriptions overlapping with those described with reference to FIGS. 1 to 10 may be omitted.

The base station may perform RA preamble detection in an one-shot scheme in the frequency domain of a plurality of observation windows (S1101). The base station may detect a delay time for each detection result in each observation window (S1101).

The base station may identify how many consecutive observation windows an RA preamble transmitted by the UE is detected in (S1103). The base station may calculate an actual delay time of the RA preamble based on the number of consecutive observation windows in which the RA preamble transmitted by the UE is detected (S1105).

When the RA preamble transmitted by the UE is detected in N consecutive observation windows, the UE may calculate an actual delay time T_{RD} of the RA preamble based on N delay times detected in the step S1101 as shown in Equation 11.

$${T}_{RD} = ( average of delay times for the respective N detection results ) \qquad [ Equation 11 ]$$

When the RA preamble transmitted by the UE is detected in (N-k) consecutive observation windows (where k is a natural number greater than or equal to 1 and less than N), the UE may determine the actual delay time TRD of the RA preamble based on (N-k) delay times detected in the step S1101. The delay time TRD may be calculated as shown in Equation 12.

$${T}_{RD} = {T}_{CP} + ( average of delay times for the respective ( N - k ) detection results ) \qquad [ Equation 12 ]$$

When the RA preamble transmitted by the UE is detected in one observation window, the UE may calculate the actual delay time T_{RD} of the RA preamble based on the one delay time detected in the step S1101 as shown in Equation 13.

$${T}_{RD} = {T}_{CP} + ( N - 2 ) \times ( {T}_{SEQ} ) + ( detected delay time ) \qquad [ Equation 13 ]$$

When the RA preamble transmitted by the UE is not detected in any observation window, the base station may determine that detection of the RA preamble has failed.

According to the exemplary embodiments of the random access method and apparatus in the wireless communication system, a PRACH bandwidth used by a UE for an RA procedure for a satellite base station in the communication system including an NTN may be set to (1/n) of a PUSCH bandwidth or set to (1/n) of a PRACH bandwidth in a terrestrial network (n is a natural number greater than 1). In addition, an RA preamble may be configured to include a plurality of different preamble sequences in the time domain or frequency domain. Through this, in the NTN having a wide cell coverage and a relatively high influence of Doppler shifts, an RA procedure with low complexity can be performed while maintaining compatibility with an RA procedure determined based on the terrestrial networks.

However, the effects that can be achieved by the exemplary embodiments of the method and apparatus for random access in the communication system are not limited to those mentioned above, and other effects not mentioned may be clearly understood by those of ordinary skill in the art to which the present disclosure belongs from the configurations described in the present disclosure.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field- programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

1. An operation method of a terminal, comprising:
receiving random access channel (RACH) configuration information from a base station included in a first network;
generating a random access (RA) preamble including a plurality of different preamble sequences based on the RACH configuration information;
mapping the RA preamble to a first frequency region; and
transmitting the RA preamble mapped to the first frequency region to the base station,
wherein a size of a bandwidth occupied by the first frequency region and a size of a bandwidth occupied by a physical uplink shared channel (PUSCH) in the first network are set to have an integer multiple relationship with each other based on the RACH configuration information.

2. The operation method according to claim 1, wherein the generating of the RA preamble comprises:
identifying information of a first format to be applied to the RA preamble based on information received from the base station; and
generating the RA preamble based on the first format,
wherein in the first format, a subcarrier spacing (SCS) configured for the RA preamble is set to have an integer multiple relationship with an SCS configured for the PUSCH.

3. The operation method according to claim 1, wherein the generating of the RA preamble comprises:
identifying information of a first format to be applied to the RA preamble based on information received from the base station; and
generating the RA preamble based on the first format,
wherein in the first format, a length of the RA preamble is set to have an integer multiple relationship with a length of an RA preamble used for an RA procedure in a second network having a coverage that is different from a cell coverage of the first network and overlaps at least partially with the cell coverage of the first network.

4. The operation method according to claim 1, wherein the generating of the RA preamble comprises:
generating a first preamble sequence and a second preamble sequence that are Zadoff-Chu sequences having a same size and generated based different root values; and
generating the RA preamble such that the first and second preamble sequences are continuously arranged with one cyclic prefix (CP) interposed therebetween in time domain.

5. The operation method according to claim 1, wherein the generating of the RA preamble comprises:
generating a first preamble sequence and a second preamble sequence that are Zadoff-Chu sequences having a same size and generated based different root values; and
generating the RA preamble such that the first and second preamble sequences are continuously arranged in time domain.

6. The operation method according to claim 1, wherein the generating of the RA preamble comprises:
generating a first preamble sequence and a second preamble sequence that are Zadoff-Chu sequences having a same size and generated based different root values; and
generating the RA preamble such that the first and second preamble sequences are continuously arranged in frequency domain.

7. An operation method of a base station, comprising:
transmitting random access channel (RACH) configuration information to one or more terminals included in a first network including the base station;
receiving, from a first terminal among the one or more terminals, a random access (RA) preamble transmitted after being mapped to a first frequency region based on the RACH configuration information; and
performing timing advance (TA) estimation for the first terminal based on a plurality of different preamble sequences included in the RA preamble,
wherein a size of a bandwidth occupied by the first frequency region and a size of a bandwidth occupied by a physical uplink shared channel (PUSCH) in the first network are set to have an integer multiple relationship with each other based on the RACH configuration information.

8. The operation method according to claim 7, wherein the transmitting of the RACH configuration information comprises:
identifying a size of a cell of the base station;
comparing the size of the cell with a first size reference;
in response to that the size of the cell exceeds the first size reference, generating the RACH configuration information including information of a first format applied to the RA preamble; and
transmitting the RACH configuration information to the one or more terminals.

9. The operation method according to claim 8, wherein in the first format, a subcarrier spacing (SCS) configured for the RA preamble is set to have an integer multiple relationship with an SCS configured for the PUSCH.

10. The operation method according to claim 8, wherein in the first format, a length of the RA preamble is set to have an integer multiple relationship with a length of an RA preamble used for an RA procedure in a second network having a coverage that is different from a cell coverage of the first network and overlaps at least partially with the cell coverage of the first network.

11. The operation method according to claim 7, wherein in the RA preamble, a first preamble sequence and a second preamble sequence that are Zadoff-Chu sequences having a same size and generated based different root values are continuously arranged with one cyclic prefix (CP) interposed therebetween in time domain.

12. The operation method according to claim 7, wherein in the RA preamble, a first preamble sequence and a second preamble sequence that are Zadoff-Chu sequences having a same size and generated based different root values are continuously arranged with one CP interposed therebetween in time domain.

13. The operation method according to claim 7, wherein in the RA preamble, a first preamble sequence and a second preamble sequence that are Zadoff-Chu sequences having a same size and generated based different root values are continuously arranged in frequency domain.

14. A terminal comprising a processor, wherein the processor causes the terminal to perform:
receiving random access channel (RACH) configuration information from a base station included in a first network;
generating a random access (RA) preamble including a plurality of different preamble sequences based on the RACH configuration information;
mapping the RA preamble to a first frequency region; and
transmitting the RA preamble mapped to the first frequency region to the base station,
wherein a size of a bandwidth occupied by the first frequency region and a size of a bandwidth occupied by a physical uplink shared channel (PUSCH) in the first network are set to have an integer multiple relationship with each other based on the RACH configuration information.

15. The terminal according to claim 14, wherein in the generating of the RA preamble, the processor further causes the terminal to perform:
identifying information of a first format to be applied to the RA preamble based on information received from the base station; and
generating the RA preamble based on the first format,
wherein in the first format, a subcarrier spacing (SCS) configured for the RA preamble is set to have an integer multiple relationship with an SCS configured for the PUSCH.

16. The terminal according to claim 14, wherein in the generating of the RA preamble, the processor further causes the terminal to perform:
identifying information of a first format to be applied to the RA preamble based on information received from the base station; and
generating the RA preamble based on the first format,
wherein in the first format, a length of the RA preamble is set to have an integer multiple relationship with a length of an RA preamble used for an RA procedure in a second network having a coverage that is different from a cell coverage of the first network and overlaps at least partially with the cell coverage of the first network.

17. The terminal according to claim 14, wherein in the generating of the RA preamble, the processor further causes the terminal to perform:
generating a first preamble sequence and a second preamble sequence that are Zadoff-Chu sequences having a same size and generated based different root values; and
generating the RA preamble such that the first and second preamble sequences are continuously arranged with one cyclic prefix (CP) interposed therebetween in time domain.

18. The terminal according to claim 14, wherein in the generating of the RA preamble, the processor further causes the terminal to perform:
generating a first preamble sequence and a second preamble sequence that are Zadoff-Chu sequences having a same size and generated based different root values; and
generating the RA preamble such that the first and second preamble sequences are continuously arranged in time domain.

19. The terminal according to claim 14, wherein in the generating of the RA preamble, the processor further causes the terminal to perform:
generating a first preamble sequence and a second preamble sequence that are Zadoff-Chu sequences having a same size and generated based different root values; and
generating the RA preamble such that the first and second preamble sequences are continuously arranged in frequency domain.
